(19) United States
(12) Patent Application Publication
(10) Pub. No.: US 2026/0187755 A1
(43) Pub. Date: Jul. 2, 2026

(54) ENHANCED SINGLE FEATURE LOCAL DIRECTIONAL PATTERN (LDP)-BASED VIDEO POST PROCESSING

(71) Applicant: Intel Corporation, Santa Clara, CA (US)

(72) Inventors: Bin WANG, Beijing (CN); Jiehui LU, Shanghai (CN); Bo PENG, Beijing (CN); Gang SHEN, Hillsboro, OR (US); Changliang WANG, Bellevue, WA (US); Yi XIE, Shanghai (CN); Zheyuan ZHANG, Shanghai (CN)

(73) Assignee: Intel Corporation, Santa Clara, CA (US)

(21) Appl. No.: 19/130,018

(22) PCT Filed: Dec. 14, 2022
(86) PCT No.: PCT/CN2022/138984

§ 371 Date: May 14, 2025

(51) Int. Cl. G06T 3/4053; G06T 5/40; G06T 5/50; G06T 5/70

(52) U.S. Cl. CPC G06T 3/4053; G06T 5/40; G06T 5/50; G06T 5/70; G06T 2207/10016; G06T 2207/20072

(57) ABSTRACT

This disclosure describes systems, methods, and devices related to video post-processing using a single local directional pattern (LDP) for multiple post-processing steps. A method may include identifying video received by a first device from a second device and decoded by the first device; generating a LDP of a video frame of the decoded video; detecting, based on the LDP and the video frame input to a blurred region detection algorithm, a blurred region and a non-blurred region of the video frame; applying, based on the LDP and the video frame input to a super resolution algorithm, super resolution on the non-blurred region of the video frame without applying the super resolution to the blurred region; and generating, based on the LDP and the video frame input to a blended image algorithm, a blended image of a low-resolution image of the video frame and a high-resolution image of the video frame.

### TECHNICAL FIELD

This disclosure generally relates to systems and methods for video processing, and more particularly, to single feature local directional pattern (LDP)-based post-processing chaining of video.

### BACKGROUND

Video conferencing applications make it easy to connect friends, colleagues, and family online. Some techniques are used in video conferencing applications to protect privacy and reduce bandwidth of streaming video, but may be time-consuming, difficult to apply in real-time, and may improperly leave video frames unblurred when they should be blurred.

### BRIEF DESCRIPTION OF THE DRAWINGS

FIG. 1 illustrates an example system of single feature local directional pattern (LDP)-based video post processing, in accordance with one or more example embodiments of the present disclosure.

FIG. 2 illustrates example Kirsch masks for use in the single feature LDP-based video post processing of FIG. 1, in accordance with one or more example embodiments of the present disclosure.

FIG. 3 illustrates example unique rotation invariant binary patterns for use in the single feature LDP-based video post processing of FIG. 1, in accordance with one or more example embodiments of the present disclosure.

FIG. 4 is a histogram of the unique rotation invariant binary patterns of FIG. 3, in accordance with one or more example embodiments of the present disclosure.

FIG. 5 illustrates a blurred region detection based on the single feature LDP-based video post processing of FIG. 1, in accordance with one or more example embodiments of the present disclosure.

FIG. 6 illustrates a flow diagram of an illustrative process for single feature LDP-based video post processing of FIG. 1, in accordance with one or more example embodiments of the present disclosure.

FIG. 7 illustrates an example video encoding and decoding system, in accordance with one or more example embodiments of the present disclosure.

FIG. 8 illustrates an embodiment of an exemplary system, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Video conferencing applications with which captured video of users communicating with one another may be encoded and transmitted to the users for presentation, is useful for business meetings, social gatherings, and the like.

Two opportunities to enhance video conferencing include privacy protection and bandwidth reduction. Some video conferencing applications provide background blur effects to protect a use's privacy and save bandwidth by streaming the blurred frames. Another method to save bit rate while maintaining video quality as much as possible is a concept referred to as Super Resolution (SR). SR enables a video sender to send low-resolution streams, then upscales the video at the receiver side to achieve good quality of the video. SR reduces the bandwidth requirement of video conference applications, but SR applied onto background blurred video frames directly has some disadvantages. For example, SR can be a time-consuming technology that can be difficult to apply to a video conference which has strict latency requirements, and SR on applied blurred background frames may result in blurred frames become deblurred and undermining a user's privacy.

Other techniques include segmenting a person and background pixels in video frames, and using a blurring algorithm to blur the background pixels. Another method is to adjust the quantization parameters of an encoder on the video sending side to blur the background. A receiver (e.g., using a decoder) may upscale a received encoded video frame using SR, for example.

Still other techniques may use a combination of compression algorithms with a lightweight SR neural network, or codecs such as Low Complexity Enhancement Video Codec (LCEVC) codec (MPEG-5 part 2).

In one or more embodiments, the present disclosure provides a single feature-based SR method in which SR may be applied to blurred background frames to reduce SR computing resources (e.g., allowing for better latency/real-time video transmission and presentation), and to provide better blurring of background pixels to ensure user privacy. The enhanced SR technique may use a single feature local directional pattern (LDP) to facilitate blurred region detection of video frames, SR on non-blurred regions of the video frames, and image blending for any artifact caused by region-based SR. SR may be applied on a content-aware region (e.g., a non-blurred region) to save network bandwidth due to single-feature LDP.

In one or more embodiments, by leveraging a single-feature LDP for three artificial intelligence post-processing operations (e.g., blurred region detection, SR on non-blurred region, and image blending for the artifact caused by region-based SR), the computational costs of the video processing may be reduced, latency may be reduced, and user privacy and experience may be enhanced. By using the three artificial intelligence post-processing operations in a chain and applying the same single-feature LDP to each of the operations, the enhancements noted above may be achieved. A highlight of the present disclosure is that the LDP feature can be applied to multiple techniques. The techniques herein identify an orientation from LDP and make it a rotation-invariant feature that can be used by techniques like local gradient techniques with faster speed compared with an eigen feature, for example. An advantage of using one feature in the post-processing chain is that it can save on heavy multi-feature calculations with just one calculation needed, and the other two processing operations of the three chained operations noted above can reuse the feature. In SR processing, the LDP feature is much more lightweight than an eigen analysis feature used by other techniques, for example, but achieves similar video quality.

In one or more embodiments, a video conference sender may send a low-resolution video stream with a background blurring effect. The sender may select whether to also send content-aware information (e.g., via the encoder), such as which region is blurred in a video frame. The enhanced post-processing techniques herein apply to scenarios when the content-aware information is provided by the encoder, and when the content-aware information is not provided by the encoder.

In one or more embodiments, because the single feature-based video post processing chaining described herein is for the decoder side (e.g., the video receiver side), the sender side code does not require any modification, allowing the enhanced techniques herein to work with any video conferencing applications without modifying them.

In one or more embodiments, determining which region of a video frame needs SR to be applied may require the content-aware region information. One way to identify the non-blurred region is from the sender side who blurred the background (e.g., by providing the content-aware information). When the sender side does not provide the content-aware information to the receiver side, the receiver side may use a blurred detection algorithm for content-aware region detection. To reduce the whole system cost time, a feature LDP may be used by the sender side for blurred region detection, and the same feature may be used by the latter two operations (e.g., SR and image blending) of the chained operations to save feature calculation cost.

LDP is one variant of LBP (Local Binary Patterns) which has been successful for computer vision problems such as classification problems, segmentation, and object detection. In some techniques, LDP computes an 8-bit binary by convolving Kirsch kernels. For each 3×3 region, the eight different directions may be convolved, wherein the edge response values are considered, then eight responses are obtained based on the derived directional. The LDP value for the pixel I_c is given by Equation (1) below:

$${LDP}_{c} = {\sum }_{i = 0}^{7} s ( {I}_{n} - {I}_{c} ) * {2}^{n} , \qquad ( 1 )$$

$$where s = \{ \begin{matrix}1 , & if x \geq 0 \\ 0 , & otherwise\end{matrix} .$$

From the eight responses, the top k responses may selected and set to 1 while the rest of the responses may be set to 0. A disadvantage of LDP is the problem of fixed number of 1s, depending on the value of k, which make its rotation invariant version unstable compared with original LBP, for example. An issue resolved by the present disclosure is that calculating eight times 3×3 convolution require significant computing resources.

In one or more embodiments, after analysis of the Kirsch masks, the techniques herein may apply two accelerated methods that significantly reduce the running time during the convolution: (1) Each pixel only needs to calculate multiplications for the number of convolution values (e.g., when the Kirsch masks have only two convolution values, each pixel calculates two multiplications—one for each of the two values). (2) Certain rows and columns in the Kirsch may be redundant (e.g., the same), so redundant rows may be marked as a same color, and the same operations do not need to be repeated for redundant rows and columns. After the accelerated calculation for Kirsch masks, the top k responses may be selected for LDP. Set k ∈ (0,8) to get nine responses. The rotation invariant LDP may be defined as performing a circular bitwise right shift that minimizes the value of the LDP code when it is interpreted as a binary number. The row of nine patterns is especially important as the patterns represent uniform patterns, containing at most two 0-1 or 1-0 transitions, making them even more robust to changes in rotation. To evaluate how to apply uniform LDP to the problem of blurred region detection, uniform LDP may be applied on blur dataset with (e.g., with 1050 blurred images), and a histogram of the nine uniform LDP patterns appearing in the blurred and non-blurred regions may be recorded. The frequency of patterns in blurred regions may be noticeably less than that for sharp regions.

In one or more embodiments, in an example, pattern number 0 is suitable to detect bright spots, pattern number 8 is suitable to detect dark spots and flat areas, and pattern number 4 for detect edges. In a blurred region, most of the neighboring pixels are similar in intensity to the center pixel, which reduces the chance of a neighbor being triggered. From statistics data, some LDP patterns (e.g., 6, 7, and 8) may be used for blurred region detection, so the algorithm may be according to Equation (2) below:

$$norm ( lbp ) = \frac{1}{N} {\sum }_{i = 6}^{8} LBP . \qquad ( 2 )$$

In one or more embodiments, calculating a number of rotation invariant uniform LDP patterns of type 6, 7, 8, may provide the normalized LDP value of type 6, 7, 8, using N as the total number of pixels in the region, defining a threshold T=0.01 to calculate the response of various levels of blur, and applying some post-processing such as erosion/dilation may result in a detected blurred region.

In one or more embodiments, once a pixel based blurred region has been obtained, the receiver side may apply SR on the content-aware region, which provides at least two advantages: (1) Saving of computational resources because SR is applied on the non-blurred region rather than the entire frame. (2) Protection of privacy. Applying SR to the entire frame may result in de-blurring of blurred background pixels, but applying SR only to the non-blurred region reduces that risk.

In one or more embodiments, a backbone solution may be applied. Some backbones may evaluate the local gradient characteristics via eigen analysis as local geometry measures, and the techniques herein apply LDP features as local geometry measures to re-use LDP features extracted by the blur region detection. Different from local gradient techniques, in the present disclosure, patches extracted from the denoised image may be separated into multiple (e.g., three) classes for magnitude, and classes for angle, and the number of filters may be reduced (e.g., to 11) to also impact the hash mechanisms. From this, the techniques herein can further improve denoising run-time while reducing memory storage requirements. Eight angles can be classed by Kirsch kernels. It may be considered that the magnitude should describe the spatial structure of the local texture using the direction of the center gray. Given image, let I_{c} denote the center pixel in patch P, and let Iₕ and Iᵥdenote the horizontal and vertical neighborhoods of I_{c}, respectively. Iₕ and Iᵥ depends on the main direction from Kirsch response, usually the maximum Kirsch response was chosen as the direction to calculate magnitude of I_{c}. Then, the magnitude at the center pixel I_{c} can be written as:

$${M}_{c} = \sqrt{{D ( {I}_{c} - {l}_{v} )}^{2} + {D ( {I}_{c} - {I}_{h} )}^{2}} , \qquad ( 3 )$$

where D denotes the direction from Kirsch masks. Two thresholds may be defined to split the M_c into three classes.

The proposed techniques herein were tested, and the unenhanced local gradient technique was used on a same dataset as the enhanced techniques herein with single feature LDP. Using PSNR (peak signal-to-noise ration) and SSIM (structural similarity) for evaluation, the experimental results show that LDP performs at a similar level of PSNR and SSIM as other methods like traditional upscaling and local gradient technique.

Regarding image blending, structure deformations may occur when applying content-aware based SR on the video frames. In one or more embodiments, an 8-bit LDP represents the local structure, which means the image blending step can re-use LDP feature as the indicator in the image blend processing. A weight method may be applied to blend a high-resolution (HR) image and low-resolution (LR) image, and the weights may be determined by the difference of the LDP value on LR images and HR images. Specifically, the LDP operations may be applied to the LR images and HR images, then normalize the weight to (0, 1). The output image can be estimated by weighted averaging of the interpolated image and the filtered image according to:

$$w = \frac{1}{N} {\sum }_{p = 0}^{p} abs ( {HR}_{lbp} - {LR}_{lbp} ) . \qquad ( 4 )$$

The above descriptions are for purposes of illustration and are not meant to be limiting. Numerous other examples, configurations, processes, algorithms, etc., may exist, some of which are described in greater detail below. Example embodiments will now be described with reference to the accompanying figures.

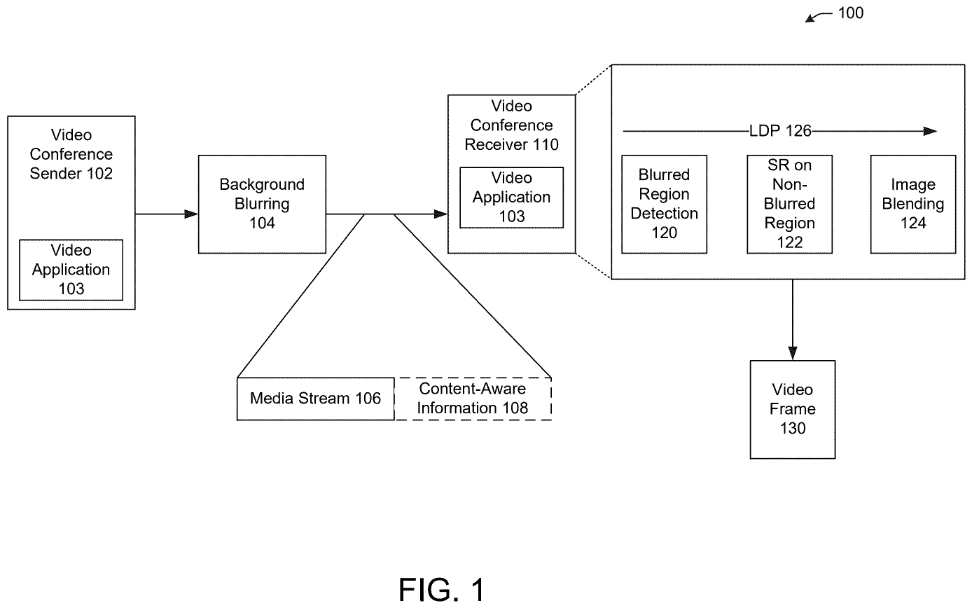

FIG. 1 illustrates an example system 100 of single feature local directional pattern (LDP)-based video post processing, in accordance with one or more example embodiments of the present disclosure.

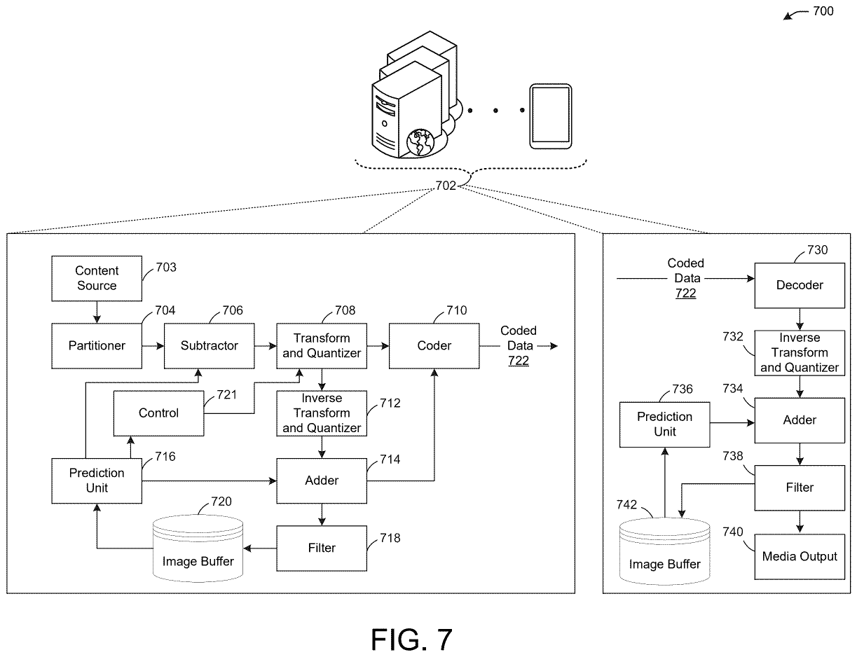

Referring to FIG. 1, a video conference sender 102 (e.g., a user device executing a video application 103) may generate and send (e.g., to one or multiple video conference recipients) video as part of an encoded bitstream for the video application 103 (e.g., a video conferencing application). Prior to sending the encoded bitstream, the video conference sender 102 may apply background blurring 104 to frames of video (e.g., showing a person, objects, and the like). Using an encoder (e.g., the coder 710 of FIG. 7), the video conference sender 102 may generate and send an encoded media stream 106 (e.g., bitstream) of video frames, and optionally may send content-aware information 108 (e.g., indicating which regions of respective video frames in the bitstream are blurred/background regions).

Still referring to FIG. 1, a video conference receiver 110 (e.g., a user device executing the video application 103) may receive the encoded media stream 106, and optionally the content-aware information 108, from the video conference sender 102. The video conference receiver 110 may decode the encoded media stream 106 (e.g., using the decoder 730 of FIG. 7) and perform post-processing on the decoded video using three operations: blurred region detection 120 on a decoded video frame, SR on the non-blurred region 122 of the decoded video frame, and image blending 124, all using a common LDP 126, resulting in a video frame 130 being output with enhanced background blurring and reduced bandwidth requirements.

In one or more embodiments, by leveraging the single-feature LDP 126 for the three artificial intelligence post-processing operations (e.g., blurred region detection 120 on a decoded video frame, SR on the non-blurred region 122 of the decoded video frame, and image blending 124), the computational costs of the video processing may be reduced, latency may be reduced, and user privacy and experience may be enhanced.

In one or more embodiments, when the video conference sender 102 does not provide the content-aware information 108 to the video conference receiver 110, the video conference receiver 110 may use the blurred detection 120 for content-aware region detection. To reduce the whole system cost time, the single feature LDP 126 may be used for the blurred region detection 120, and the same single feature LDP 126 may be used by the latter two operations (e.g., SR on the non-blurred region 122 and image blending 124) of the chained operations to save feature calculation cost.

In some techniques, the LDP 126 computes an 8-bit binary by convolving Kirsch kernels. For each 3×3 region, the eight different directions may be convolved, wherein the edge response values are considered, then eight responses are obtained based on the derived directional. From the eight responses, the top k responses may selected and set to 1 while the rest of the responses may be set to 0.

In one or more embodiments, after analysis of the Kirsch masks, the LDP 126 may apply two accelerated methods that significantly reduce the running time during the convolution: (1) Each pixel only needs to calculate multiplications for the number of convolution values (e.g., when the Kirsch masks have only two convolution values, each pixel calculates two multiplications-one for each of the two values). (2) Certain rows and columns in the Kirsch may be redundant (e.g., the same), so redundant rows may be marked as a same color, and the same operations do not need to be repeated for redundant rows and columns. After the accelerated calculation for Kirsch masks, the top k responses may be selected for LDP. Set k ∈ (0,8) to get nine responses. The rotation invariant LDP may be defined as performing a circular bitwise right shift that minimizes the value of the LDP code when it is interpreted as a binary number. The row of nine patterns is especially important as the patterns represent uniform patterns, containing at most two 0-1 or 1-0 transitions, making them even more robust to changes in rotation.

In one or more embodiments, in an example, pattern number 0 is suitable to detect bright spots, pattern number 8 is suitable to detect dark spots and flat areas, and pattern number 4 for detect edges. In a blurred region, most of the neighboring pixels are similar in intensity to the center pixel, which reduces the chance of a neighbor being triggered. From statistics data, some LDP patterns (e.g., 6, 7, and 8) may be used for blurred region detection, so the algorithm may be according to Equation (2) above.

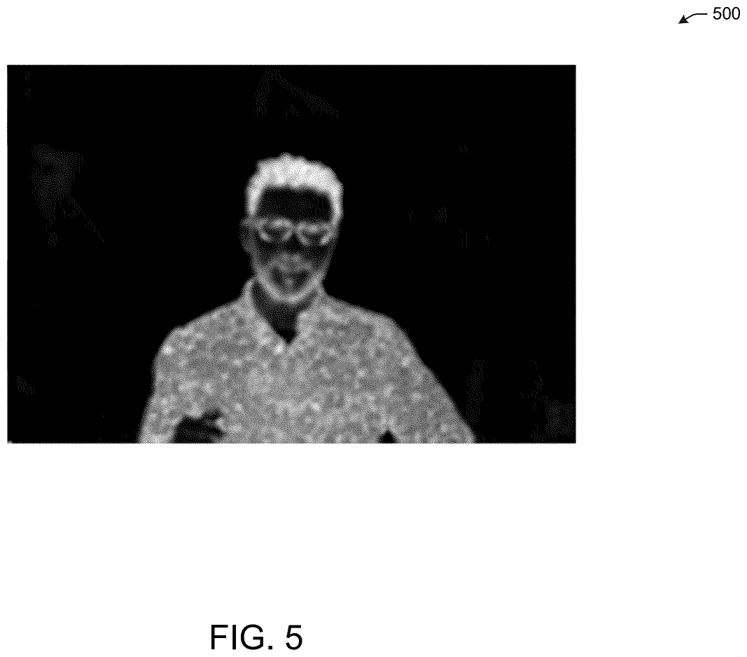

In one or more embodiments, calculating a number of rotation invariant uniform LDP patterns of type 6, 7, 8, may provide the normalized LDP value of type 6, 7, 8, using N as the total number of pixels in the region, defining a threshold T=0.01 to calculate the response of various levels of blur, and applying some post-processing such as erosion/dilation may result in a detected blurred region by the blurred region detection 120 (e.g., as shown in FIG. 5).

In one or more embodiments, once a pixel based blurred region has been obtained, the video conference receiver 110 may apply SR on the non-blurred region 122, which provides at least two advantages: (1) Saving of computational resources because SR is applied on the non-blurred region rather than the entire frame. (2) Protection of privacy. Applying SR to the entire frame may result in de-blurring of blurred background pixels, but applying SR only to the blurred region reduces that risk.

In one or more embodiments, a backbone solution may be applied. Different from local gradient techniques, in the present disclosure, patches extracted from the denoised image may be separated into multiple (e.g., three) classes for magnitude, and classes for angle, and the number of filters may be reduced (e.g., to 11) to also impact the hash mechanisms. From this, the video conference receiver 110 may further improve denoising run-time while reducing memory storage requirements. Eight angles can be classed by Kirsch kernels. It may be considered that the magnitude should describe the spatial structure of the local texture using the direction of the center gray. Given image, let I_{c} denote the center pixel in patch P, and let Iₕ and Iᵥdenote the horizontal and vertical neighborhoods of I_{c}, respectively. Iₕ and lᵥ depends on the main direction from Kirsch response, usually the maximum Kirsch response was chosen as the direction to calculate magnitude of I_{c}. Then, the magnitude at the center pixel I_{c} can be written as Equation (3) above.

In one or more embodiments, for the image blending 124, structure deformations may occur when applying content-aware based SR on the video frames. In one or more embodiments, an 8-bit LDP represents the local structure, which means the image blending step can re-use LDP feature as the indicator in the image blend processing. A weight method may be applied to blend a high-resolution (HR) image and low-resolution (LR) image, and the weights may be determined by the difference of the LDP value on LR images and HR images. Specifically, the LDP operations may be applied to the LR images and HR images, then normalize the weight to (0, 1). The output image can be estimated by weighted averaging of the interpolated image and the filtered image according to Equation (4) above.

Because the LDP 126 is a simpler and faster metric calculation than other metrics that may be used for video frame blurring (e.g., a local gradient analysis), the video frame 130 may have enhanced blurring and may use fewer network and computational resources.

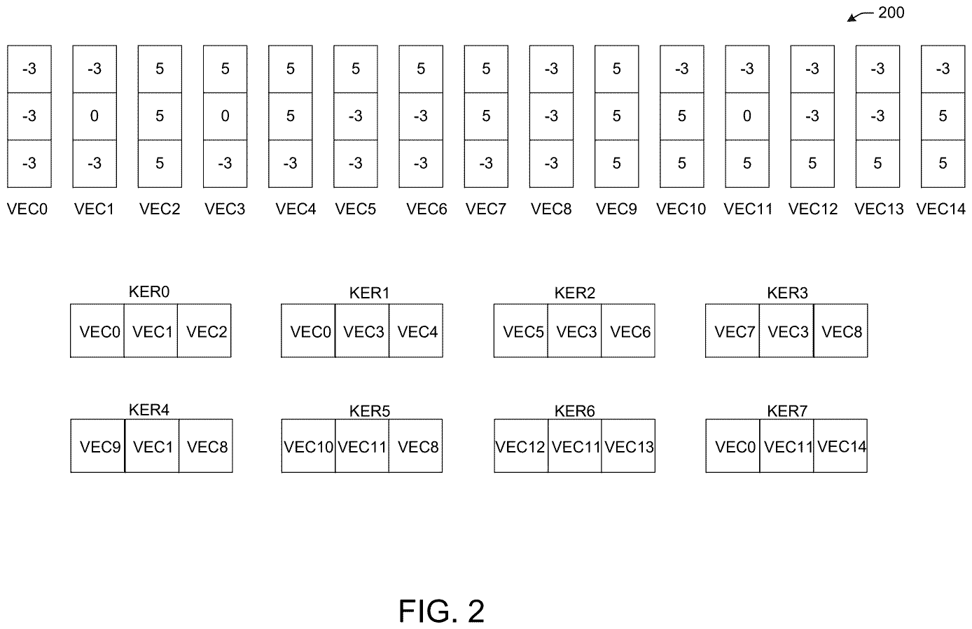

FIG. 2 illustrates example Kirsch masks 200 for use in the single feature LDP-based video post processing of FIG. 1, in accordance with one or more example embodiments of the present disclosure.

Referring to FIG. 2, as noted above with respect to FIG. 1, the LDP 126 may compute an 8-bit binary, and the LDP value for each pixel may be provided by applying Equation (1) above, resulting in eight responses (e.g., Kirsch masks KER0, KER1, KER2, KER3, KER4, KER5, KER6, KER7). The eight Kirsch masks have only two convolution values in the example shown in FIG. 2 (other implementations may have other numbers of different convolution values): −3 and 5. Therefore, each pixel only needs to calculate a multiplication for −3 and a multiplication of 5.

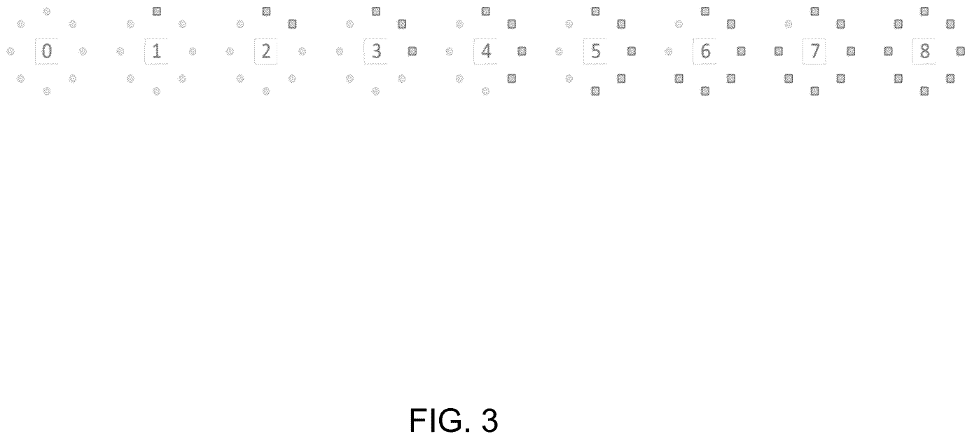

In addition, still referring to FIG. 2, some rows and columns (e.g., VEC0-VEC14) are redundant. For example, FIG. 2 shows columns of −3, −3, −3 (e.g., VEC0 and VEC8). The same columns may be armed as a same color, and there is no need to perform the same operations on more than one of the columns (e.g., avoid the same operations on the redundant columns). After the accelerated calculation for Kirsch masks, top k responses will be selected for LDP. We set k∈(0,8) to get 9 responds. The rotation invariant LDP was defined as performing the circular bitwise right shift that minimizes the value of the LDP code when it is interpreted as a binary number. FIG. 3 shows the unique rotation invariant binary patterns that can occur in k∈(0,8) points.

FIG. 3 illustrates example unique rotation invariant binary patterns 300 for use in the single feature LDP-based video post processing of FIG. 1, in accordance with one or more example embodiments of the present disclosure.

Referring to FIG. 3, the unique rotation invariant binary patterns 300 may be generated by the LDP 126 of FIG. 1 using the Kirsch masks of FIG. 2 as described above. The unique rotation invariant binary patterns 300 represent uniform patterns, containing at most two 0-1 or 1-0 transitions, making them even more robust to changes in rotation.

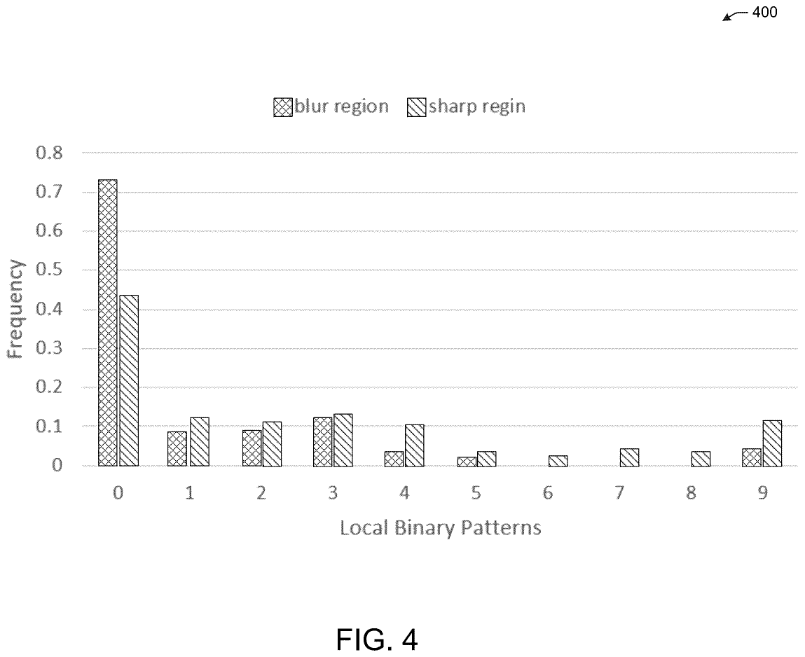

FIG. 4 is a histogram 400 of the unique rotation invariant binary patterns 300 of FIG. 3, in accordance with one or more example embodiments of the present disclosure.

To generate the histogram 400, uniform LDP (e.g., the LDP 126 of FIG. 1) may be applied to a dataset of blurred images, and recoding of the uniform LDP patterns appearing in the blurred and non-blurred regions may be applied. As a result, the histogram 400 shows that the frequency of patterns 6, 7, and 8 of the unique rotation invariant binary patterns 300 of FIG. 3 is less than for sharper regions.

Still referring to FIG. 4, pattern 0 may be suitable to detect bright spots. Pattern 8 may be suitable for detecting dark spots and flat areas. Pattern 4 may be suitable for detecting edges. In this manner, in a blurred region, most neighboring pixels are similar in intensity from the center pixel, which reduces the chance of a neighbor pixel being triggered.

FIG. 5 illustrates a blurred region detection 500 based on the single feature LDP-based video post processing of FIG. 1, in accordance with one or more example embodiments of the present disclosure.

Because the LDP patterns 6-8 (e.g., FIGS. 3-4) may be used for region detection, Equation (2) above may be applied to get the normalized LDP value of types 6-8. A threshold (e.g., T=0.01) may be used to calculate the response of various blurring levels, and post-processing such as erosion/dilation may be applied to generate the blurred region detection 500.

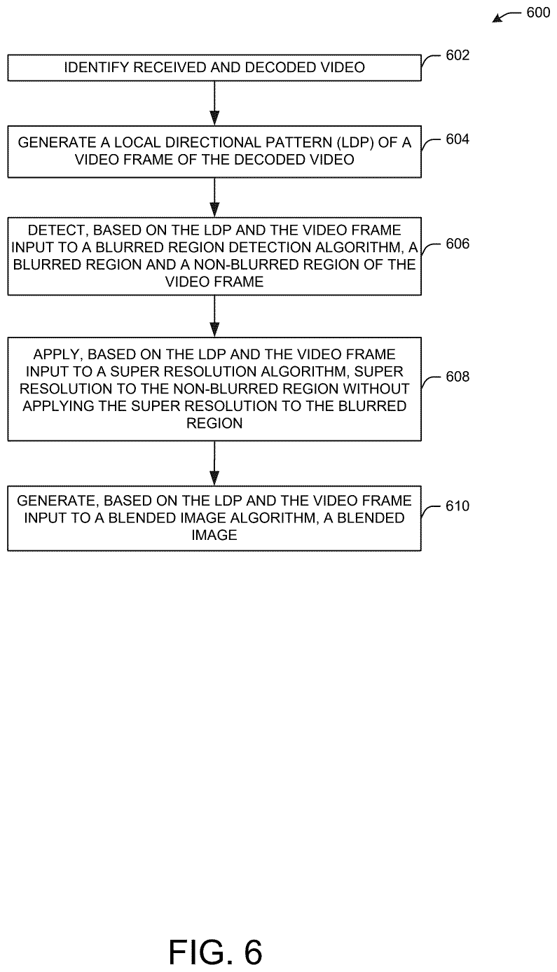

FIG. 6 illustrates a flow diagram of an illustrative process 600 for single feature LDP-based video post processing of FIG. 1, in accordance with one or more example embodiments of the present disclosure.

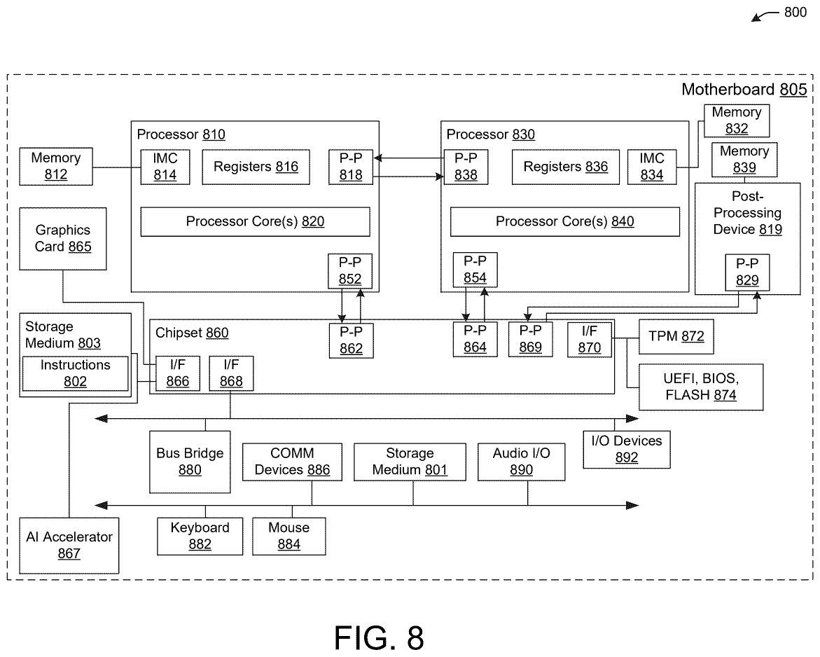

At block 602, a device (e.g., the video conference receiver 110 of FIG. 1, the post-processing device 819 of FIG. 8) may identify video that has been received from a device and has been decoded (e.g., the media stream 106). The video may or may not be sent along with content-aware information.

At block 604, the device may generate a LDP of a video frame of the decoded video. LDP is one variant of LBP (Local Binary Patterns) which has been successful for computer vision problems such as classification problems, segmentation, and object detection. In some techniques, LDP computes an 8-bit binary by convolving Kirsch kernels. For each 3×3 region, the eight different directions may be convolved, wherein the edge response values are considered, then eight responses are obtained based on the derived directional. The LDP value for the pixel I_c is given by Equation (1) above. From the eight responses, the top k responses may selected and set to 1 while the rest of the responses may be set to 0. In one or more embodiments, after analysis of the Kirsch masks, the techniques herein may apply two accelerated methods that significantly reduce the running time during the convolution: (1) Each pixel only needs to calculate multiplications for the number of convolution values (e.g., when the Kirsch masks have only two convolution values, each pixel calculates two multiplications-one for each of the two values). (2) Certain rows and columns in the Kirsch may be redundant (e.g., the same), so redundant rows may be marked as a same color, and the same operations do not need to be repeated for redundant rows and columns. After the accelerated calculation for Kirsch masks, the top k responses may be selected for LDP.

At block 606, the device may detect, based on inputting the LDP and the video frame to a blurred region detection algorithm (e.g., the blurred region detection 120 of FIG. 1), the blurred and non-blurred regions of the video frame. When the content-aware information is provided by the device that sent the video, the content-aware information may indicate where the blurred and non-blurred regions are in a video frame. Otherwise, the device may identify unique rotation invariant binary patterns based on the LDP, generate a histogram based on the unique rotation invariant binary patterns, use the histogram to identify unique rotation invariant binary patterns having lower frequencies, which indicate a higher likelihood of corresponding to a blurred region.

At block 608, the device may apply, based on inputting the LDP and the video frame to a super resolution algorithm (e.g., the SR on non-blurred region 122 of FIG. 1), super resolution (e.g., upscaling) to the non-blurred region without using SR on the blurred region (e.g., saving resources by not applying SR to the blurred region).

At block 610, the device may generate, based on the LDP and the video frame being input to a blended image algorithm (e.g., the image blending 124 of FIG. 1), a blended image for the video frame. Structure deformations may occur when applying content-aware based SR on the video frames. In one or more embodiments, an 8-bit LDP represents the local structure, which means the image blending step can re-use LDP feature as the indicator in the image blend processing. A weight method may be applied to blend a high-resolution (HR) image and low-resolution (LR) image, and the weights may be determined by the difference of the LDP value on LR images and HR images. Specifically, the LDP operations may be applied to the LR images and HR images, then normalize the weight to (0, 1). The output (e.g., blended) image can be estimated by weighted averaging of the interpolated image and the filtered image according to Equation (4) above.

FIG. 7 illustrates an example video encoding and decoding system 700, in accordance with one or more example embodiments of the present disclosure.

Referring to FIG. 7, the system 700 may include devices 702 having encoder and/or decoder components. As shown, the devices 702 may include a content source 703 that provides video and/or audio content (e.g., a camera or other image capture device, stored images/video, etc.). The content source 703 may provide media (e.g., video and/or audio) to a partitioner 704, which may prepare frames of the content for encoding. A subtractor 706 may generate a residual as explained further herein. A transform and quantizer 708 may generate and quantize transform units to facilitate encoding by a coder 710 (e.g., entropy coder). Transform and quantized data may be inversely transformed and inversely quantized by an inverse transform and quantizer 712. An adder 714 may compare the inversely transformed and inversely quantized data to a prediction block generated by a prediction unit 716, resulting in reconstructed frames. A filter 718 (e.g., in-loop filter for resizing/cropping, color conversion, de-interlacing, composition/blending, etc.) may revise the reconstructed frames from the adder 714, and may store the reconstructed frames in an image buffer 720 for use by the prediction unit 716. A control 721 may manage many encoding aspects (e.g., parameters) including at least the setting of a quantization parameter (QP) but could also include setting bitrate, rate distortion or scene characteristics, prediction and/or transform partition or block sizes, available prediction mode types, and best mode selection parameters, for example, based at least partly on data from the prediction unit 716. Using the encoding aspects, the transform and quantizer 708 may generate and quantize transform units to facilitate encoding by the coder 710, which may generate coded data 722 that may be transmitted (e.g., an encoded bitstream).

Still referring to FIG. 7, the devices 702 may receive coded data (e.g., the coded data 722) in a bitstream, and a decoder 730 may decode the coded data, extracting quantized residual coefficients and context data. An inverse transform and quantizer 732 may reconstruct pixel data based on the quantized residual coefficients and context data. An adder 734 may add the residual pixel data to a predicted block generated by a prediction unit 736. A filter 738 may filter the resulting data from the adder 734. The filtered data may be output by a media output 740, and also may be stored as reconstructed frames in an image buffer 742 for use by the prediction unit 736.

Referring to FIG. 7, the system 700 performs the methods of intra prediction disclosed herein, and is arranged to perform at least one or more of the implementations described herein including intra block copying. In various implementations, the system 700 may be configured to undertake video coding and/or implement video codecs according to one or more standards. Further, in various forms, video coding system 700 may be implemented as part of an image processor, video processor, and/or media processor and undertakes inter-prediction, intra-prediction, predictive coding, and residual prediction. In various implementations, system 700 may undertake video compression and decompression and/or implement video codecs according to one or more standards or specifications, such as, for example, H.264 (Advanced Video Coding, or AVC), VP8, H.265 (High Efficiency Video Coding or HEVC) and SCC extensions thereof, VP9, Alliance Open Media Version 1 (AV1), H.266 (Versatile Video Coding, or VVC), DASH (Dynamic Adaptive Streaming over HTTP), LCEVC, and others. Although system 100 and/or other systems, schemes or processes may be described herein, the present disclosure is not necessarily always limited to any particular video coding standard or specification or extensions thereof except for IBC prediction mode operations where mentioned herein.

As used herein, the term “coder” may refer to an encoder and/or a decoder. Similarly, as used herein, the term “coding” may refer to encoding via an encoder and/or decoding via a decoder. A coder, encoder, or decoder may have components of both an encoder and decoder. An encoder may have a decoder loop as described below.

For example, the system 700 may be an encoder where current video information in the form of data related to a sequence of video frames may be received to be compressed. By one form, a video sequence (e.g., from the content source 703) is formed of input frames of synthetic screen content such as from, or for, business applications such as word processors, power points, or spread sheets, computers, video games, virtual reality images, and so forth. By other forms, the images may be formed of a combination of synthetic screen content and natural camera captured images. By yet another form, the video sequence only may be natural camera captured video. The partitioner 704 may partition each frame into smaller more manageable units, and then compare the frames to compute a prediction. If a difference or residual is determined between an original block and prediction, that resulting residual is transformed and quantized, and then entropy encoded and transmitted in a bitstream, along with reconstructed frames, out to decoders or storage. To perform these operations, the system 700 may receive an input frame from the content source 703. The input frames may be frames sufficiently pre-processed for encoding.

The system 700 also may manage many encoding aspects including at least the setting of a quantization parameter (QP) but could also include setting bitrate, rate distortion or scene characteristics, prediction and/or transform partition or block sizes, available prediction mode types, and best mode selection parameters to name a few examples.

The output of the transform and quantizer 708 may be provided to the inverse transform and quantizer 712 to generate the same reference or reconstructed blocks, frames, or other units as would be generated at a decoder such as decoder 730. Thus, the prediction unit 716 may use the inverse transform and quantizer 712, adder 714, and filter 718 to reconstruct the frames.

The prediction unit 716 may perform inter-prediction including motion estimation and motion compensation, intra-prediction according to the description herein, and/or a combined inter-intra prediction. The prediction unit 716 may select the best prediction mode (including intra-modes) for a particular block, typically based on bit-cost and other factors. The prediction unit 716 may select an intra-prediction and/or inter-prediction mode when multiple such modes of each may be available. The prediction output of the prediction unit 716 in the form of a prediction block may be provided both to the subtractor 706 to generate a residual, and in the decoding loop to the adder 714 to add the prediction to the reconstructed residual from the inverse transform to reconstruct a frame.

The partitioner 704 or other initial units not shown may place frames in order for encoding and assign classifications to the frames, such as I-frame, B-frame, P-frame and so forth, where I-frames are intra-predicted. Otherwise, frames may be divided into slices (such as an I-slice) where each slice may be predicted differently. Thus, for HEVC or AV1 coding of an entire I-frame or I-slice, spatial or intra-prediction is used, and in one form, only from data in the frame itself.

The prediction unit 716 may select previously decoded reference blocks. Then comparisons may be performed to determine if any of the reference blocks match a current block being reconstructed. This may involve hash matching, SAD search, or other comparison of image data, and so forth. Once a match is found with a reference block, the prediction unit 716 may use the image data of the one or more matching reference blocks to select a prediction mode. By one form, previously reconstructed image data of the reference block is provided as the prediction, but alternatively, the original pixel image data of the reference block could be provided as the prediction instead. Either choice may be used regardless of the type of image data that was used to match the blocks.

The predicted block then may be subtracted at subtractor 706 from the current block of original image data, and the resulting residual may be partitioned into one or more transform blocks (TUs) so that the transform and quantizer 708 can transform the divided residual data into transform coefficients using discrete cosine transform (DCT) for example. Using the quantization parameter (QP) set by the system 700, the transform and quantizer 708 then uses lossy resampling or quantization on the coefficients. The frames and residuals along with supporting or context data block size and intra displacement vectors and so forth may be entropy encoded by the coder 710 and transmitted to decoders.

In one or more embodiments, a system 700 may have, or may be, a decoder, and may receive coded video data in the form of a bitstream and that has the image data (chroma and luma pixel values) and as well as context data including residuals in the form of quantized transform coefficients and the identity of reference blocks including at least the size of the reference blocks, for example. The context also may include prediction modes for individual blocks, other partitions such as slices, inter-prediction motion vectors, partitions, quantization parameters, filter information, and so forth. The system 700 may process the bitstream with an entropy decoder 730 to extract the quantized residual coefficients as well as the context data. The system 700 then may use the inverse transform and quantizer 732 to reconstruct the residual pixel data.

The system 700 then may use an adder 734 (along with assemblers not shown) to add the residual to a predicted block. The system 700 also may decode the resulting data using a decoding technique employed depending on the coding mode indicated in syntax of the bitstream, and either a first path including a prediction unit 736 or a second path that includes a filter 738. The prediction unit 736 performs intra-prediction by using reference block sizes and the intra displacement or motion vectors extracted from the bitstream, and previously established at the encoder. The prediction unit 736 may utilize reconstructed frames as well as inter-prediction motion vectors from the bitstream to reconstruct a predicted block. The prediction unit 736 may set the correct prediction mode for each block, where the prediction mode may be extracted and decompressed from the compressed bitstream.

In one or more embodiments, the coded data 722 may include both video and audio data. In this manner, the system 700 may encode and decode both audio and video.

It is understood that the above descriptions are for purposes of illustration and are not meant to be limiting.

It is understood that the above descriptions are for purposes of illustration and are not meant to be limiting.

FIG. 8 illustrates an embodiment of an exemplary system 800, in accordance with one or more example embodiments of the present disclosure.

In various embodiments, the system 800 may comprise or be implemented as part of an electronic device.

In some embodiments, the system 800 may be representative, for example, of a computer system that implements one or more components of FIG. 1.

The embodiments are not limited in this context. More generally, the system 800 is configured to implement all logic, systems, processes, logic flows, methods, equations, apparatuses, and functionality described herein and with reference to the figures.

The system 800 may be a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other devices for processing, displaying, or transmitting information. Similar embodiments may comprise, e.g., entertainment devices such as a portable music player or a portable video player, a smartphone or other cellular phones, a telephone, a digital video camera, a digital still camera, an external storage device, or the like. Further embodiments implement larger-scale server configurations. In other embodiments, the system 800 may have a single processor with one core or more than one processor. Note that the term “processor” refers to a processor with a single core or a processor package with multiple processor cores.

In at least one embodiment, the computing system 800 is representative of one or more components of FIG. 1. More generally, the computing system 800 is configured to implement all logic, systems, processes, logic flows, methods, apparatuses, and functionality described herein with reference to the above figures.

As used in this application, the terms “system” and “component” and “module” are intended to refer to a computer-related entity, either hardware, a combination of hardware and software, software, or software in execution, examples of which are provided by the exemplary system 1100. For example, a component can be but is not limited to being, a process running on a processor, a processor, a hard disk drive, multiple storage drives (of optical and/or magnetic storage medium), an object, an executable, a thread of execution, a program, and/or a computer.

By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 800 comprises a motherboard 805 for mounting platform components. The motherboard 805 is a point-to-point (P-P) interconnect platform that includes a processor 810, a processor 830 coupled via a P-P interconnects/interfaces as an Ultra Path Interconnect (UPI), and a post-processing device 819. In other embodiments, the system 800 may be of another bus architecture, such as a multi-drop bus. Furthermore, each of processors 810 and 830 may be processor packages with multiple processor cores. As an example, processors 810 and 830 are shown to include processor core(s) 820 and 840, respectively. While the system 800 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 810 and the chipset 860. Some platforms may include additional components and some platforms may only include sockets to mount the processors and/or the chipset.

The processors 810 and 830 can be any of various commercially available processors, including without limitation an Intel® Celeron®, Core®, Core (2) Duo®, Itanium®, Pentium®, Xeon®, and XScale® processors; AMD® Athlon®, Duron®, and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processors 810, and 830.

The processor 810 includes an integrated memory controller (IMC) 814 and P-P interconnects/interfaces 818 and 852. Similarly, the processor 830 includes an IMC 834 and P-P interconnects/interfaces 838 and 854. The IMC's 814 and 834 couple the processors 810 and 830, respectively, to respective memories, a memory 812, and a memory 832. The memories 812 and 832 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 812 and 832 locally attach to the respective processors 810 and 830.

In addition to the processors 810 and 830, the system 800 may include the post-processing device 819. The post-processing device 819 may be connected to chipset 860 by means of P-P interconnects/interfaces 829 and 869. The post-processing device 819 may also be connected to a memory 839. In some embodiments, the post-processing device 819 may be connected to at least one of the processors 810 and 830. In other embodiments, the memories 812, 832, and 839 may couple with the processor 810 and 830, and the post-processing device 819 via a bus and shared memory hub.

System 800 includes chipset 860 coupled to processors 810 and 830. Furthermore, chipset 860 can be coupled to storage medium 803, for example, via an interface (I/F) 866. The I/F 866 may be, for example, a Peripheral Component Interconnect-enhanced (PCI-e). The processors 810, 1130, and the post-processing device 819 may access the storage medium 803 through chipset 860.

Storage medium 803 may comprise any non-transitory computer-readable storage medium or machine-readable storage medium, such as an optical, magnetic, or semiconductor storage medium. In various embodiments, storage medium 803 may comprise an article of manufacture. In some embodiments, storage medium 803 may store computer-executable instructions, such as computer-executable instructions 802 to implement one or more of processes or operations described herein, (e.g., process 600 of FIG. 6). The storage medium 803 may store computer-executable instructions for any equations depicted above. The storage medium 803 may further store computer-executable instructions for models and/or networks described herein, such as a neural network or the like. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable types of code, such as source code, compiled code, interpreted code, executable code, static code, dynamic code, object-oriented code, visual code, and the like. It should be understood that the embodiments are not limited in this context.

The processor 810 couples to a chipset 860 via P-P interconnects/interfaces 852 and 862 and the processor 830 couples to a chipset 860 via P-P interconnects/interfaces 854 and 864. Direct Media Interfaces (DMIs) may couple the P-P interconnects/interfaces 852 and 862 and the P-P interconnects/interfaces 854 and 864, respectively. The DMI may be a high-speed interconnect that facilitates, e.g., eight Giga Transfers per second (GT/s) such as DMI 3.0. In other embodiments, the processors 810 and 830 may interconnect via a bus.

The chipset 860 may comprise a controller hub such as a platform controller hub (PCH). The chipset 860 may include a system clock to perform clocking functions and include interfaces for an I/O bus such as a universal serial bus (USB), peripheral component interconnects (PCIs), serial peripheral interconnects (SPIs), integrated interconnects (12 Cs), and the like, to facilitate connection of peripheral devices on the platform. In other embodiments, the chipset 860 may comprise more than one controller hub such as a chipset with a memory controller hub, a graphics controller hub, and an input/output (I/O) controller hub.

In the present embodiment, the chipset 860 couples with a trusted platform module (TPM) 872 and the UEFI, BIOS, Flash component 874 via an interface (I/F) 870. The TPM 872 is a dedicated microcontroller designed to secure hardware by integrating cryptographic keys into devices. The UEFI, BIOS, Flash component 874 may provide pre-boot code.

Furthermore, chipset 860 includes the I/F 866 to couple chipset 860 with a high-performance graphics engine, graphics card 865. The graphics card 865 may implement one or more of processes or operations described herein, (e.g., process 6 of FIG. 6), and may include components of FIG. 1. In other embodiments, the system 800 may include a flexible display interface (FDI) between the processors 810 and 830 and the chipset 860. The FDI interconnects a graphics processor core in a processor with the chipset 860.

Various I/O devices 892 couple to the bus 881, along with a bus bridge 880 that couples the bus 881 to a second bus 891 and an I/F 868 that connects the bus 881 with the chipset 860. In one embodiment, the second bus 891 may be a low pin count (LPC) bus. Various devices may couple to the second bus 891 including, for example, a keyboard 882, a mouse 884, communication devices 886, a storage medium 801, and an audio I/O 890.

The artificial intelligence (AI) accelerator 867 may be circuitry arranged to perform computations related to AI. The AI accelerator 867 may be connected to storage medium 801 and chipset 860. The AI accelerator 867 may deliver the processing power and energy efficiency needed to enable abundant data computing. The AI accelerator 867 is a class of specialized hardware accelerators or computer systems designed to accelerate artificial intelligence and machine learning applications, including artificial neural networks and machine vision. The AI accelerator 867 may be applicable to algorithms for robotics, internet of things, other data-intensive and/or sensor-driven tasks.

Many of the I/O devices 892, communication devices 886, and the storage medium 801 may reside on the motherboard 805 while the keyboard 882 and the mouse 884 may be add-on peripherals. In other embodiments, some or all the I/O devices 892, communication devices 886, and the storage medium 801 are add-on peripherals and do not reside on the motherboard 805.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories that provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions that, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. Integrated circuits, processor packages, chip packages, and chipsets may comprise one or more processors.

Processors may receive signals such as instructions and/or data at the input(s) and process the signals to generate at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Various example embodiments are provided below.

Example 1 may include method for single feature local directional pattern (LDP)-based post-processing of video, the method comprising: identifying, by at least one processor associated with a first device, video received by the first device from a second device and decoded by the first device; generating, by the at least one processor, a LDP of a video frame of the decoded video; detecting, by the at least one processor, based on the LDP and the video frame input to a blurred region detection algorithm, a blurred region and a non-blurred region of the video frame; applying, by the at least one processor, based on the LDP and the video frame input to a super resolution algorithm, super resolution on the non-blurred region of the video frame without applying the super resolution to the blurred region; and generating, by the at least one processor, based on the LDP and the video frame input to a blended image algorithm, a blended image of a low-resolution image of the video frame and a high-resolution image of the video frame.

Example 2 may include the method of example 1 and/or any other example herein, wherein generating the LDP comprises: generating Kirsch kernels for the video frame; and convolving a subset of the Kirsch kernels.

Example 3 may include the method of example 2 and/or any other example herein, further comprising: identifying repeated rows and columns of the Kirsch kernels; selecting one row or column of the repeated rows or columns; and discarding the unselected rows or columns of the repeated rows or columns.

Example 4 may include the method of example 3 and/or any other example herein, further comprising: convolving the selected row or column of the repeated row or column; and selecting the subset based on the convolving for the LDP.

Example 5 may include the method of any of examples 1-4 and/or any other example herein, wherein detecting the blurred region and the non-blurred region of the video frame comprises: identifying unique rotation invariant binary patterns based on the LDP; generating a histogram based on the unique rotation invariant binary patterns; determining, based on the histogram, that a first frequency of a first unique rotation invariant binary pattern is less than a second frequency of a second unique rotation invariant binary pattern; and determining, based on the first frequency being less than the second frequency, that the first unique rotation invariant binary pattern is associated with the blurred region and that the second unique rotation invariant binary pattern is associated with the non-blurred region.

Example 6 may include the method of any of examples 1-5 and/or any other example herein, wherein generating the blended image comprises: generating a weighted average of the high-resolution image and the low-resolution image using weights based on a difference of values of the LDP for the high-resolution image and for the low-resolution image.

Example 7 may include the method of any examples 1-6 and/or any other example herein, further comprising: receiving, from the second device, content-aware information indicative of where the blurred region is located in the video frame, wherein detecting the blurred region is based on the content-aware information.

Example 8 may include the method of any examples 1-6 and/or any other example herein, wherein detecting the blurred region is unassociated with receiving, from the second device, content-aware information indicative of where the blurred region is located in the video frame.

Example 9 may include a computer-readable storage medium comprising instructions to perform the method of any of examples 1-8 and/or any other example herein.

Example 10 may include an apparatus comprising means for performing the method of any of examples 1-8 and/or any other example herein.

Example 11 may include a computer-readable medium storing computer-executable instructions, associated with video post-processing, which when executed by one or more processors result in performing operations comprising: identifying video received by a first device from a second device and decoded by the first device; generating a LDP of a video frame of the decoded video; detecting, based on the LDP and the video frame input to a blurred region detection algorithm, a blurred region and a non-blurred region of the video frame; applying, based on the LDP and the video frame input to a super resolution algorithm, super resolution on the non-blurred region of the video frame without applying the super resolution to the blurred region; and generating, based on the LDP and the video frame input to a blended image algorithm, a blended image of a low-resolution image of the video frame and a high-resolution image of the video frame.

Example 12 may include the computer-readable medium of example 11 and/or any other example herein, wherein generating the LDP comprises: generating Kirsch kernels for the video frame; and convolving a subset of the Kirsch kernels.

Example 13 may include the computer-readable medium of example 12 and/or any other example herein, the operations further comprising: identifying repeated rows and columns of the Kirsch kernels; selecting one row or column of the repeated rows or columns; and discarding the unselected rows or columns of the repeated rows or columns.

Example 14 may include the computer-readable medium of example 13 and/or any other example herein, the operations further comprising: convolving the selected row or column of the repeated row or column; and selecting the subset based on the convolving for the LDP.

Example 15 may include the computer-readable medium of any of examples 11-14 and/or any other example herein, wherein detecting the blurred region and the non-blurred region of the video frame comprises: identifying unique rotation invariant binary patterns based on the LDP; generating a histogram based on the unique rotation invariant binary patterns; determining, based on the histogram, that a first frequency of a first unique rotation invariant binary pattern is less than a second frequency of a second unique rotation invariant binary pattern; and determining, based on the first frequency being less than the second frequency, that the first unique rotation invariant binary pattern is associated with the blurred region and that the second unique rotation invariant binary pattern is associated with the non-blurred region.

Example 16 may include the computer-readable medium of any of examples 1-15 and/or any other example herein, wherein generating the blended image comprises: generating a weighted average of the high-resolution image and the low-resolution image using weights based on a difference of values of the LDP for the high-resolution image and for the low-resolution image.

Example 17 may include the computer-readable medium of any of examples 11-16, the operations further comprising: receiving, from the second device, content-aware information indicative of where the blurred region is located in the video frame, wherein detecting the blurred region is based on the content-aware information.

Example 18 may include the computer-readable medium of any of examples 11-16 and/or any other example herein, wherein detecting the blurred region is unassociated with receiving, from the second device, content-aware information indicative of where the blurred region is located in the video frame.

Example 19 may include a device for video post-processing, the device comprising memory storing instructions associated with the video post-processing, the memory coupled to at least one processor configured to: identify video received by the device from a second device and decoded by the device; generate a LDP of a video frame of the decoded video; detect, based on the LDP and the video frame input to a blurred region detection algorithm, a blurred region and a non-blurred region of the video frame; apply, based on the LDP and the video frame input to a super resolution algorithm, super resolution on the non-blurred region of the video frame without applying the super resolution to the blurred region; and generate, based on the LDP and the video frame input to a blended image algorithm, a blended image of a low-resolution image of the video frame and a high-resolution image of the video frame.

Example 20 may include the device of example 19 and/or any other example herein, wherein to generate the LDP comprises to: generate Kirsch kernels for the video frame; and convolve a subset of the Kirsch kernels.

Example 21 may include the device of example 20 and/or any other example herein, wherein the at least one processor is further configured to: identify repeated rows and columns of the Kirsch kernels; select one row or column of the repeated rows or columns; and discard the unselected rows or columns of the repeated rows or columns.

Example 22 may include the device of example 21 and/or any other example herein, wherein the at least one processor is further configured to: convolve the selected row or column of the repeated row or column; and select the subset based on the convolving for the LDP.

Example 23 may include the device of any of examples 19-22 and/or any other example herein, wherein to detect the blurred region and the non-blurred region of the video frame comprises to: identify unique rotation invariant binary patterns based on the LDP; generate a histogram based on the unique rotation invariant binary patterns; determine, based on the histogram, that a first frequency of a first unique rotation invariant binary pattern is less than a second frequency of a second unique rotation invariant binary pattern; and determine, based on the first frequency being less than the second frequency, that the first unique rotation invariant binary pattern is associated with the blurred region and that the second unique rotation invariant binary pattern is associated with the non-blurred region.

Example 24 may include the device of any of examples 19-23 and/or any other example herein, wherein to generate the blended image comprises to: generate a weighted average of the high-resolution image and the low-resolution image using weights based on a difference of values of the LDP for the high-resolution image and for the low-resolution image.

Example 25 may include the device of any of examples 19-24 and/or any other example herein, wherein the at least one processor is further configured to: receive, from the second device, content-aware information indicative of where the blurred region is located in the video frame, wherein to detect the blurred region is based on the content-aware information.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

1-25. (canceled)

26. An apparatus comprising:
interface circuitry;
computer readable instructions; and
at least one programmable circuit to be programmed by the computer readable instructions to:
generate a local directional pattern (LDP) of a video frame of a video;
detect, based on the LDP and a blurred region detection algorithm, a blurred region and a non-blurred region of the video frame;
apply, based on the LDP and a super resolution algorithm, super resolution on the non-blurred region of the video frame without applying the super resolution to the blurred region; and
generate, based on the LDP and a blended image algorithm, a blended image of a low-resolution image of the video frame and a high-resolution image of the video frame.

27. The apparatus of claim 26, wherein to generate the LDP, one or more of the at least one programmable circuit is to:
generate Kirsch kernels for the video frame; and
convolve a subset of the Kirsch kernels.

28. The apparatus of claim 27, wherein one or more of the at least one programmable circuit is to:
identify repeated rows and columns of the Kirsch kernels;
select one row or column of the repeated rows or columns; and
discard the unselected rows or columns of the repeated rows or columns.

29. The apparatus of claim 28, wherein one or more of the at least one programmable circuit is to:
convolve the selected row or column of the repeated row or column; and
select the subset based on the convolving for the LDP.

30. The apparatus of claim 26, wherein to detect the blurred region and the non-blurred region of the video frame, one or more of the at least one programmable circuit is to:
identify unique rotation invariant binary patterns based on the LDP;
generate a histogram based on the unique rotation invariant binary patterns;
determine, based on the histogram, that a first frequency of a first unique rotation invariant binary pattern is less than a second frequency of a second unique rotation invariant binary pattern; and
determine, based on the first frequency being less than the second frequency, that the first unique rotation invariant binary pattern is associated with the blurred region and that the second unique rotation invariant binary pattern is associated with the non-blurred region.

31. The apparatus of claim 26, wherein to generate the blended image, one or more of the at least one programmable circuit is to generate a weighted average of the high-resolution image and the low-resolution image based on weights, the weights based on a difference of values of the LDP for the high-resolution image and for the low-resolution image.

32. The apparatus of claim 26, wherein one or more of the at least one programmable circuit is to obtain content-aware information indicative of where the blurred region is located in the video frame, the blurred region detected based on the content-aware information.

33. An article of manufacture comprising computer-readable instructions to cause at least one programmable circuit to at least:
generate a local directional pattern (LDP) of a video frame of a video;
detect, based on the LDP and a blurred region detection algorithm, a blurred region and a non-blurred region of the video frame;
apply, based on the LDP and a super resolution algorithm, super resolution on the non-blurred region of the video frame without applying the super resolution to the blurred region; and
generate, based on the LDP and a blended image algorithm, a blended image of a low-resolution image of the video frame and a high-resolution image of the video frame.

34. The article of manufacture of claim 33, wherein the computer-readable instructions are to cause one or more of the at least one programmable circuit to:
generate Kirsch kernels for the video frame; and
convolve a subset of the Kirsch kernels.

35. The article of manufacture of claim 34, wherein the computer-readable instructions are to cause one or more of the at least one programmable circuit to:
identify repeated rows and columns of the Kirsch kernels;
select one row or column of the repeated rows or columns; and
discard the unselected rows or columns of the repeated rows or columns.

36. The article of manufacture of claim 35, wherein the computer-readable instructions are to cause one or more of the at least one programmable circuit to:
convolve the selected row or column of the repeated row or column; and
select the subset based on the convolving for the LDP.

37. The article of manufacture of claim 33, wherein the computer-readable instructions are to cause one or more of the at least one programmable circuit to detect the blurred region and the non-blurred region of the video frame by:
identifying unique rotation invariant binary patterns based on the LDP;
generating a histogram based on the unique rotation invariant binary patterns;
determining, based on the histogram, that a first frequency of a first unique rotation invariant binary pattern is less than a second frequency of a second unique rotation invariant binary pattern; and
determining, based on the first frequency being less than the second frequency, that the first unique rotation invariant binary pattern is associated with the blurred region and that the second unique rotation invariant binary pattern is associated with the non-blurred region.

38. The article of manufacture of claim 33, wherein to generate the blended image, the computer-readable instructions are to cause one or more of the at least one programmable circuit to generate a weighted average of the high-resolution image and the low-resolution image based on weights, the weights based on a difference of values of the LDP for the high-resolution image and for the low-resolution image.

39. The article of manufacture of claim 33, wherein the computer-readable instructions are to cause one or more of the at least one programmable circuit to obtain content-aware information indicative of where the blurred region is located in the video frame, the blurred region detected based on the content-aware information.

40. A method comprising:
generating, by at least one programmable circuit programmed based on at least one instruction, a local directional pattern (LDP) of a video frame of a video;
detecting, based on the LDP and a blurred region detection algorithm, a blurred region and a non-blurred region of the video frame;
applying, based on the LDP and a super resolution algorithm, super resolution on the non-blurred region of the video frame without applying the super resolution to the blurred region; and
generating, based on the LDP and a blended image algorithm, a blended image of a low-resolution image of the video frame and a high-resolution image of the video frame.

41. The method of claim 40, wherein the generating of the LDP includes:
generating Kirsch kernels for the video frame; and
convolving a subset of the Kirsch kernels.

42. The method of claim 41, including:
identifying repeated rows and columns of the Kirsch kernels;
selecting one row or column of the repeated rows or columns;
discarding the unselected rows or columns of the repeated rows or columns;
convolving the selected row or column of the repeated row or column; and
selecting the subset based on the convolving for the LDP.

43. The method of claim 40, wherein the detecting of the blurred region and the non-blurred region of the video frame includes:
identifying unique rotation invariant binary patterns based on the LDP;
generating a histogram based on the unique rotation invariant binary patterns;
determining, based on the histogram, that a first frequency of a first unique rotation invariant binary pattern is less than a second frequency of a second unique rotation invariant binary pattern; and
determining, based on the first frequency being less than the second frequency, that the first unique rotation invariant binary pattern is associated with the blurred region and that the second unique rotation invariant binary pattern is associated with the non-blurred region.

44. The method of claim 40, wherein the generating of the blended image includes generating a weighted average of the high-resolution image and the low-resolution image based on weights, the weights based on a difference of values of the LDP for the high-resolution image and for the low-resolution image.

45. The method of claim 40, including obtaining content-aware information indicative of where the blurred region is located in the video frame, the blurred region detected based on the content-aware information.
